(19) United States
(12) Patent Application Publication
(10) Pub. No.: US 2006/0199012 A1
(43) Pub. Date: Sep. 7, 2006

(54) Manufacture of porous diamond films

(76) Inventor: Kramadhati V. Ravi, Atherton, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/418,647

(22) Filed: May 5, 2006

Related U.S. Application Data
(62) Division of application No. 10/823,836, filed on Apr. 13, 2004.

(51) Int. Cl. B32B 9/00

(52) U.S. Cl. 428/408; 428/702

(57) ABSTRACT

Methods of forming a microelectronic structure are described. Those methods comprise forming a diamond layer on a substrate, wherein a portion of the diamond layer comprises defects; and then forming pores in the diamond layer by removing the defects from the diamond layer.

This application is a divisional of Ser. No. 10/823,836 filed on Apr. 13, 2004.

### FIELD OF THE INVENTION

The present invention generally relates to the field of microelectronic devices, and more particularly to methods of fabricating porous diamond films exhibiting low dielectric constants and high mechanical strength.

### BACK GROUND OF THE INVENTION

Microelectronic devices typically include conductive layers, such as metal interconnect lines, which are insulated from each other by dielectric layers, such as interlayer dielectric (ILD) layers. As device features shrink, the distance between the metal lines on each layer of a device is reduced, and thus the capacitance of the device may increase. This increase in capacitance may contribute to such detrimental effects such as RC delay, and capacitively coupled signals (also known as cross-talk).

To address this problem, insulating materials that have relatively low dielectric constants (referred to as low-k dielectrics) are being used in place of silicon dioxide (and other materials that have relatively high dielectric constants) to form the dielectric layer (ILD) that separates the metal lines. However, many currently used low-k ILD materials have a low mechanical strength that may lead to mechanical and structural problems during subsequent wafer processing, such as during assembly and packaging operations.

It is well known that diamond films exhibit very high mechanical strength. However, the dielectric constant of diamond films as deposited by such processes as chemical vapor deposition are typically about 5.7. It would be helpful to provide a diamond film which exhibits both a low k dielectric constant and a high mechanical strength for utilization in the fabrication of microelectronic devices.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIGS. 1a-1c represent structures according to an embodiment of the present invention.

FIG. 2 represents a flow chart according to an embodiment of the present invention.

FIG. 3 represents a cluster tool according to another embodiment of the present invention.

FIGS. 4a-4e represent structures according to another embodiment of the present invention.

FIG. 5 represents a flow chart according to another embodiment of the present invention.

FIGS. 6a-6e represent structures according to another embodiment of the present invention.

FIG. 7 represents a structure from the prior art.

### DETAILED DESCRIPTION OF THE PRESENT INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein, in connection with one embodiment, may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Methods and associated structures of forming a microelectronic device are described. Those methods comprise forming a diamond layer on a substrate, wherein the diamond layer comprises defects, and then forming pores in the diamond layer by removing the defects from the diamond layer.

Removing the defects from the diamond layer enables the fabrication of a high strength, low k dielectric ILD material that can withstand subsequent assembly and packaging operations without exhibiting mechanical failure.

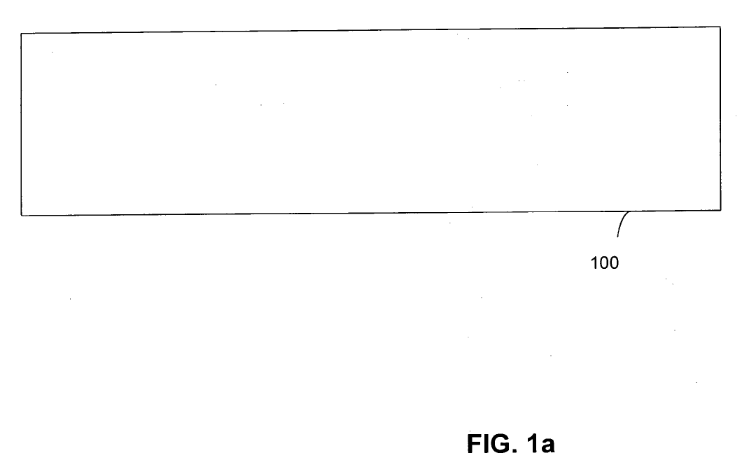

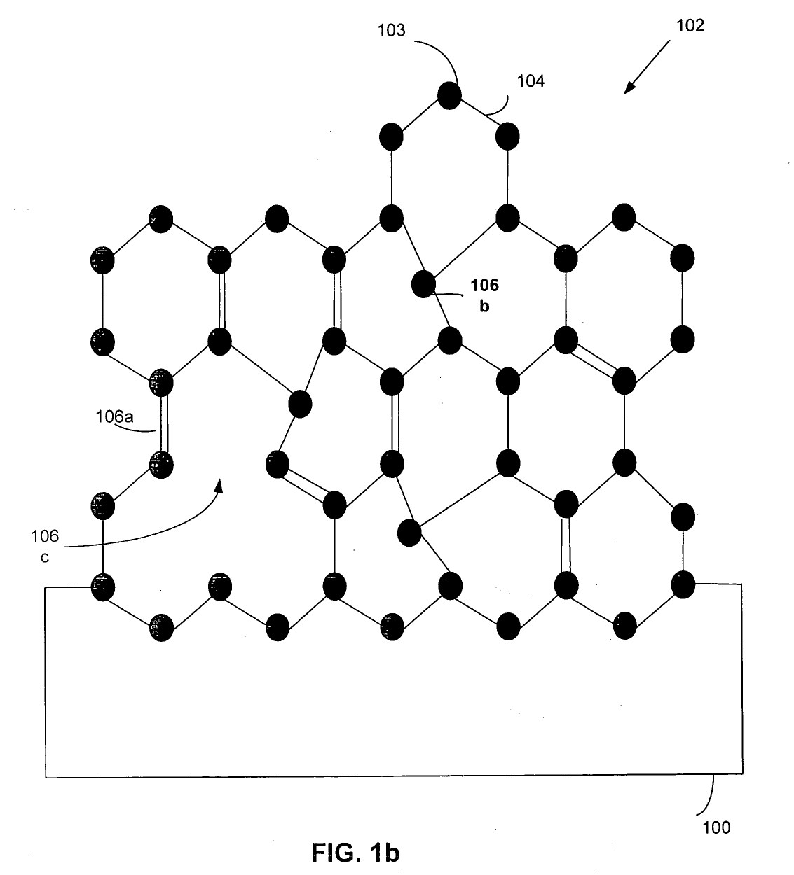

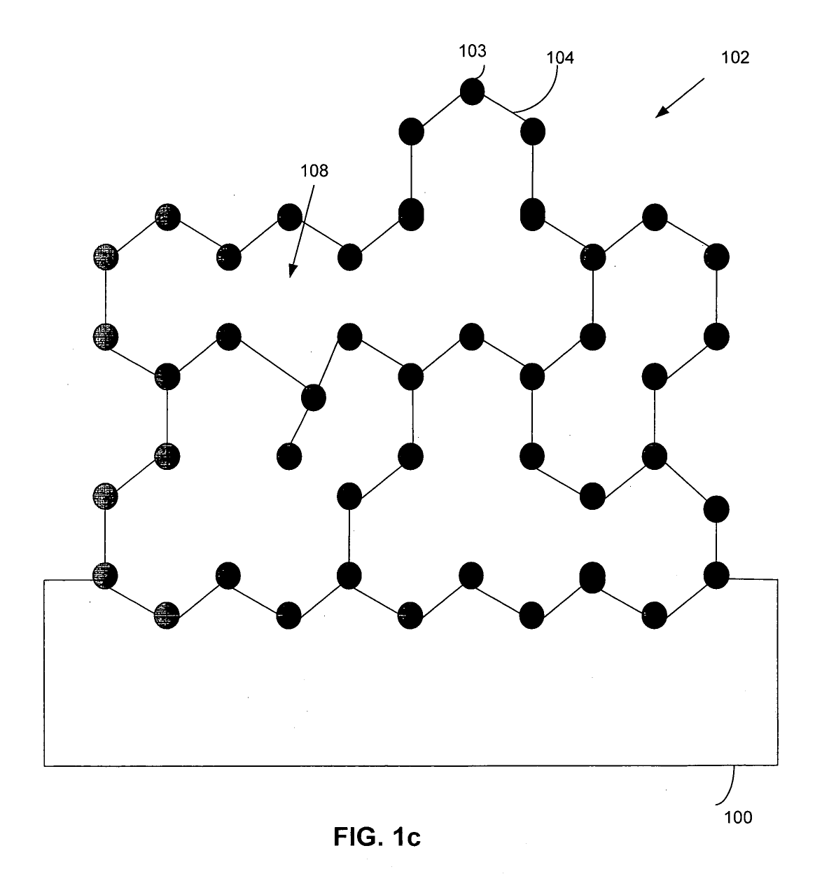

FIGS. 1a-1c illustrate an embodiment of a method and associated structures of forming a diamond layer comprising a low dielectric constant and high mechanical strength. FIG. 1a illustrates a cross-section of a portion of a substrate 100. The substrate 100 may be comprised of materials such as, but not limited to, silicon, silicon-on-insulator, germanium, indium, antimonide, lead telluride, indium arsenide, indium phosphide, gallium arsenide, gallium antimonide, or combinations thereof.

A diamond layer 102 may be formed on the substrate 100 (FIG. 1b). The diamond layer 102 may be formed utilizing conventional methods suitable for the deposition of diamond films known in the art, such as chemical vapor deposition (“CVD”). In one embodiment, the process pressure may be in a range from about 10 to 100 Torr, a temperature of about 300 to 900 degrees, and a power between about 10 kW to about 200 kW. Methods of plasma generation may include DC glow discharge CVD, filament assisted CVD and microwave enhanced CVD.

In one embodiment, hydrocarbon gases such as CH₄, C₂H₂, fullerenes or solid carbon gas precursors may be used to form the diamond layer 102, with CH4 (methane) being preferred. The hydrocarbon gas may be mixed with hydrogen gas at a concentration of at least about 10 percent hydrocarbon gas in relation to the concentration of hydrogen gas. Hydrocarbon concentrations of about 10 percent or greater generally result in the formation of a diamond layer 102 that may comprise a substantial amount of defects 106 in the crystal lattice of the diamond layer 102, such as double bonds 106a, interstitial atoms 106b and vacancies 106c, as are known in the art (FIG. 1b). It will be understood by those skilled in the art that the defects 106 may comprise any non-sp3 type forms of diamond bonding as well as any forms of anomalies, such as graphite or non-diamond forms of carbon, in the crystal lattice.

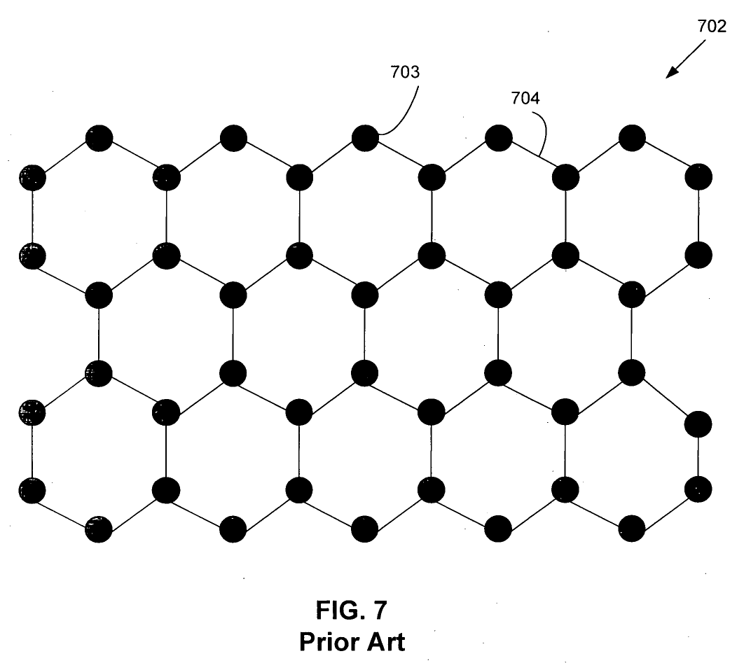

The diamond layer 102 of the present invention may comprise a mixture of bonding types between the atoms 103 of the crystal lattice of the diamond layer 102. The diamond layer 102 may comprise a mixture of double bonds 106a, also known as sp2 type bonding to those skilled in the art, and single bonds 104, known as sp3 type bonding to those skilled in the art. The diamond layer 102 of the present invention comprises a greater percentage of defects 106 (i.e., the amount of defects 106 may range from about 10 percent to greater than about 60 percent) than prior art, “pure-type” diamond layers 702 (FIG. 7), which typically comprise a predominance of sp3 type bonding (i.e., carbon atoms 703 bonded together by single bonds 704) and generally comprise few other types of defects.

The defects 106 may be selectively removed, or etched, from the diamond layer 102. In one embodiment, the defects 106 may be removed by utilizing an oxidation process, for example. Such an oxidation process may comprise utilizing molecular oxygen and heating the diamond layer 102 to a temperature less than about 450 degrees Celsius. Another oxidation process that may be used is utilizing molecular oxygen and a rapid thermal processing (RTP) apparatus, as is well known in the art. The defects 106 may also be removed from the diamond layer 102 by utilizing an oxygen and/or a hydrogen plasma, as are known in the art.

By selectively etching the defects 106 from the crystal lattice of the diamond layer 102, pores 108 may be formed (FIG. 1c). The pores 108 may comprise clusters of missing atoms or vacancies in the crystal lattice. The pores are formed by the selective removal of a substantial amount of the defects 106 from the lattice, since the oxidation and/or plasma removal processes will remove, or etch, the defects 106 in the diamond layer 102 while not appreciably etching the single bonds 104 of the diamond layer 102. The pores 108 lower the dielectric constant of the diamond layer 102 because the pores 108 are voids in the lattice which have a dielectric constant near one.

After the pores 108 have been formed, the diamond layer 102 may comprise a dielectric constant that may be below about 2.0, and in one embodiment is preferably below about 1.95. The presence of the rigid sp3 bonds in the porous diamond layer 102 confers the benefits of the high mechanical strength of a “pure” type diamond film with the low dielectric constant of a porous film. The strength modulus of the porous diamond layer 102 may comprise a value of above about 6 GPa. Thus, by introducing porosity, voids and other such internal discontinuities into the diamond lattice, the methods of the present invention enable the formation of a low dielectric constant, high mechanical strength diamond layer 102.

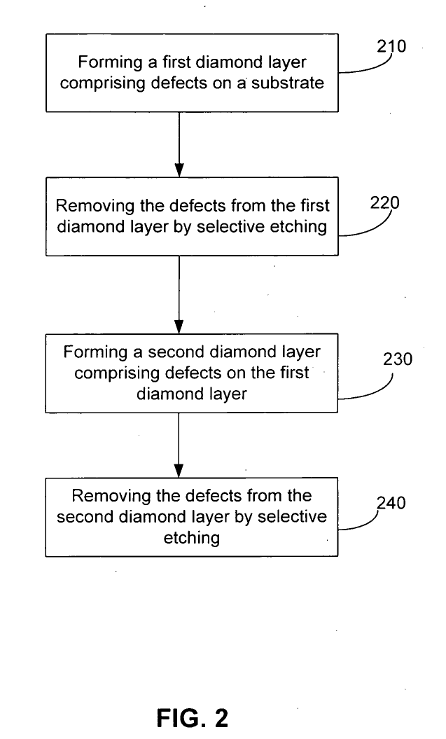

FIG. 2 depicts a flowchart of a method according to another embodiment of the present invention. At step 210, a first diamond layer is formed on a substrate, wherein the first diamond layer comprises defects, similar to the diamond layer 102 of FIG. 1b. At step 220, the defects are removed from the diamond layer by selective etching. At step 230, a second diamond layer comprising defects is formed on the first diamond layer. At step 240, the defects are removed from the second diamond layer. The dielectric constant of the diamond layer 102 may be tailored by varying the number of deposition cycles and etching cycles according to particular design requirements.

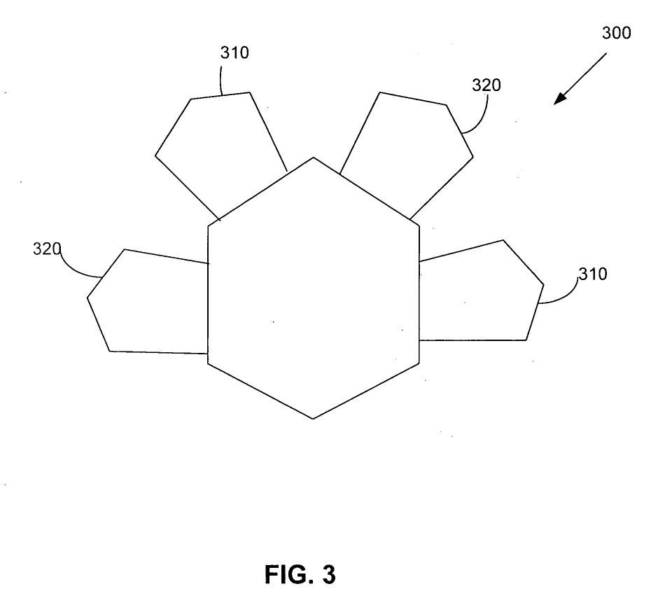

It will be understood by those in the art that the first diamond layer may be deposited in a deposition chamber 310 of a cluster tool 300 (FIG. 3). The removal of the defects from the first diamond layer may then be accomplished in a separate oxidation chamber 320 of the chamber tool. In this manner, the thickness and porosity of the diamond layer 102 may be precisely controlled in order to produce a diamond layer 102 that possesses the required dielectric constant and mechanical strength for a particular application. Alternatively, the formation and defect removal process steps may also be performed in the same process chamber. In either case, process variables such as the ratio between the hydrocarbon gas and the hydrogen gas during the deposition step and the etch time during the removal step may be adjusted to provide greater process latitude according to particular design considerations.

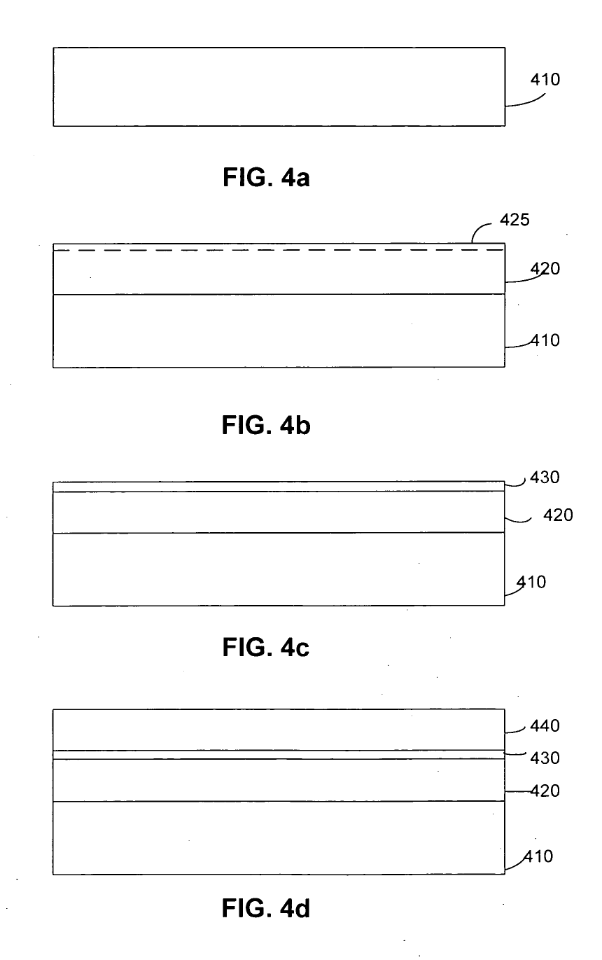

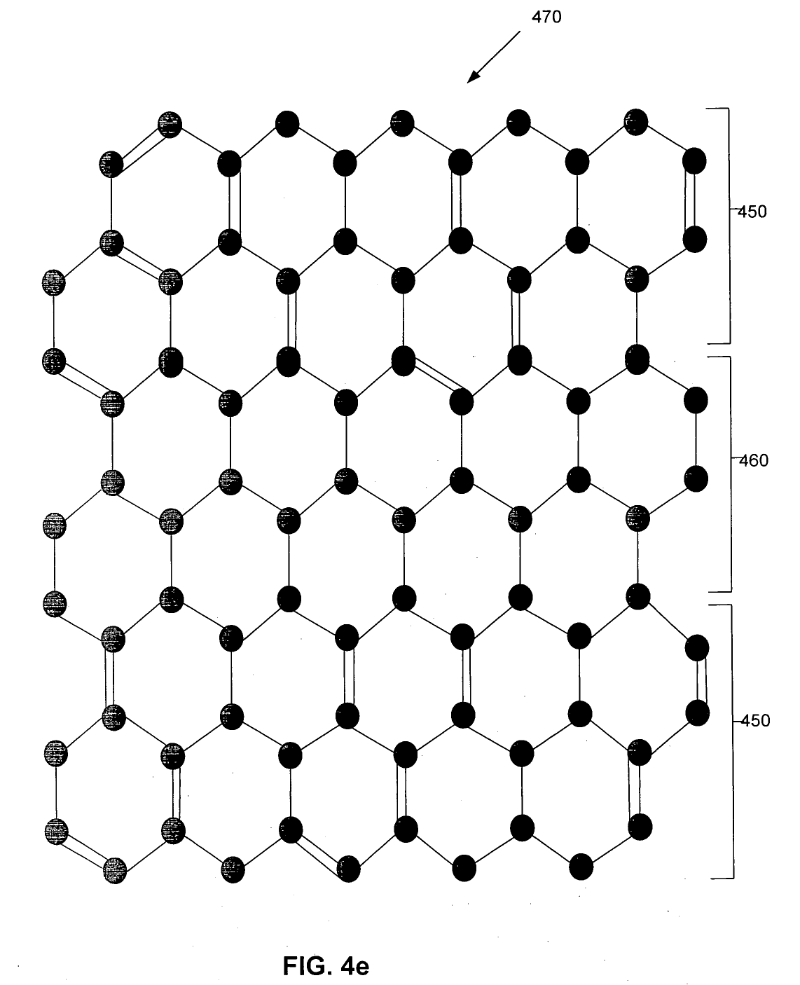

FIGS. 4a-4e depict another embodiment of the present invention. FIG. 4a illustrates a cross-section of a portion of a substrate 410 similar to the substrate 100 of FIG. 1a. A first diamond layer 420 may then be formed on the substrate 410 (FIG. 4b). The first diamond layer 420 may comprise a mixture of sp2 type bonds (double bonds) and sp3 type bonds (single bonds). The first diamond layer 420 may comprise a top portion 425. The first diamond layer 420 may be formed using similar process conditions as are used to form the diamond layer 102, as described previously herein.

The percentage of sp2 type bonds in the first diamond layer 420 may be increased by increasing the percentage of hydrocarbon gas to methane gas in the plasma used during formation. The dielectric constant of the first diamond layer 420 will decrease as the percentage of hydrocarbon is increased in the gas mixture, due to the increase in sp2 type bonds in the first diamond layer 420. For example, at about 30 percent hydrocarbon gas, the dielectric constant may comprise about 2.0, and may decrease with further increase of the hydrocarbon percentage. The dielectric constant achieved will of course depend on the deposition conditions of the particular application. In one embodiment, the thickness of the first diamond layer 420 may range from about 5 nm to about 100 nm, but will depend on the particular application.

After the first diamond layer 420 is deposited on the substrate 410, the first diamond layer 420 is exposed to a hydrogen plasma, as is well known in the art. The hydrogen plasma removes a substantial amount of the sp2 bonds from the top portion 425 of the first diamond layer 420, by preferentially etching the sp2 bonds, as well as any other types of defects (as described previously herein) in the first diamond layer 420. In this manner, the top portion 425 of the first diamond layer 420 is converted into a substantially sp2 free diamond layer 430, wherein the bonds of the substantially sp2 free diamond layer 430 comprise primarily sp3 bonds (FIG. 4c). Alternatively, the substantially sp2 free diamond layer 430 may be formed on the first diamond layer 420 by using a CVD process, for example.

A second diamond layer 440 may then be deposited on the first diamond layer 420 (FIG. 4d). The second diamond layer 440 may preferably comprise a mixture of sp2 bonds and sp3 bonds, similar to the first diamond layer 420. Another substantially sp2 free diamond layer (not shown) may be formed on the second diamond layer 440, and in this manner a series of alternating layers of sp2 rich diamond layers 450 and sp3 rich diamond layers 460 may be formed (FIG. 4e).

Thus, the current embodiment enables the formation of a layered diamond structure 470 which possesses the advantages of a low dielectric constant with high mechanical strength, due to the sp3 rich layers which impart strength to the diamond layer formed according to the methods of the present invention.

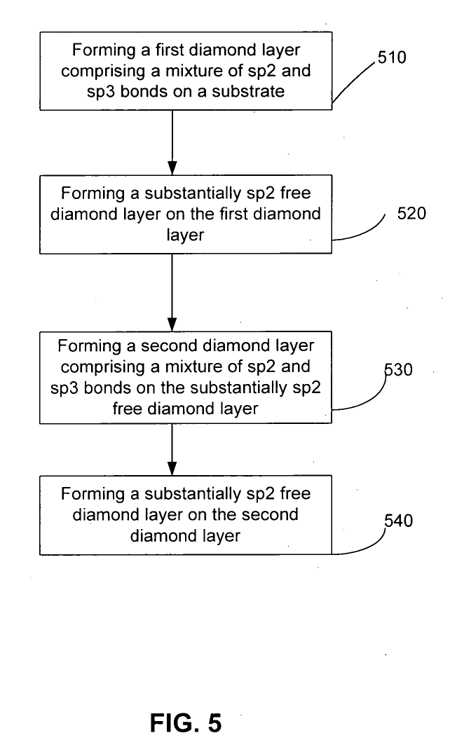

FIG. 5 depicts a flowchart of a method according to the current embodiment of the present invention. At step 510, a first diamond layer comprising a mixture of sp2 and sp3 bonds is formed on a substrate. At step 520, a substantially sp2 free diamond layer is formed on the first diamond layer. At step 530, a second diamond layer comprising a mixture of sp2 and sp3 bonds is formed on the substantially sp2 free diamond layer. At step 540, a substantially sp2 free diamond layer is formed on the second diamond layer.

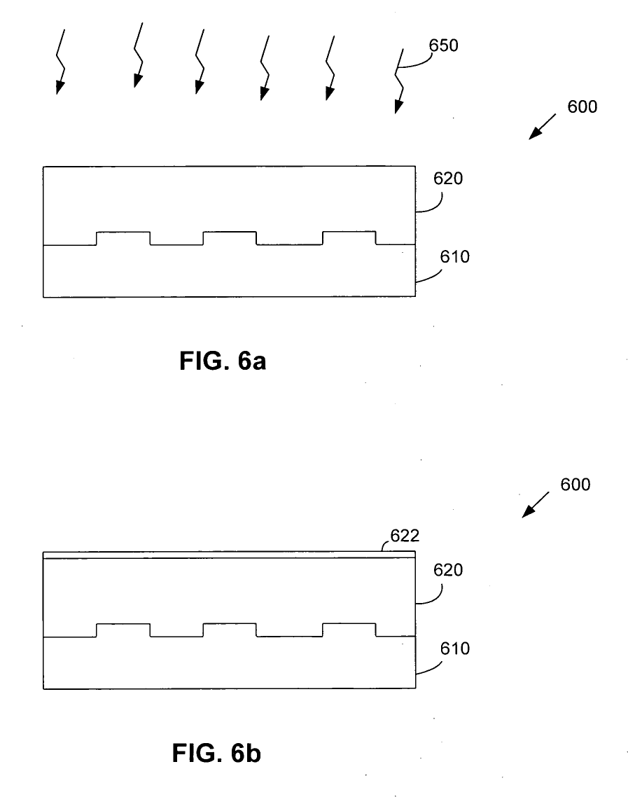

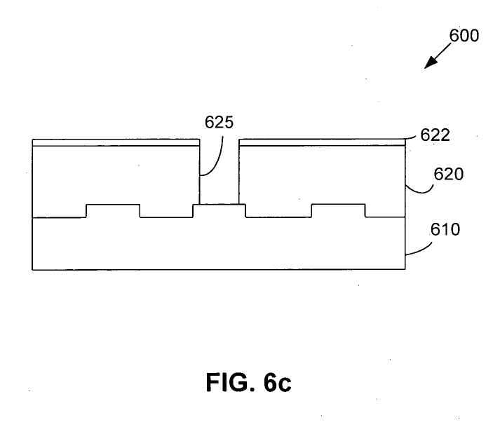

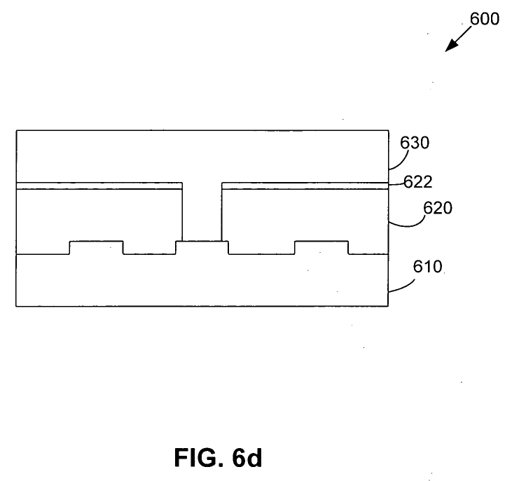

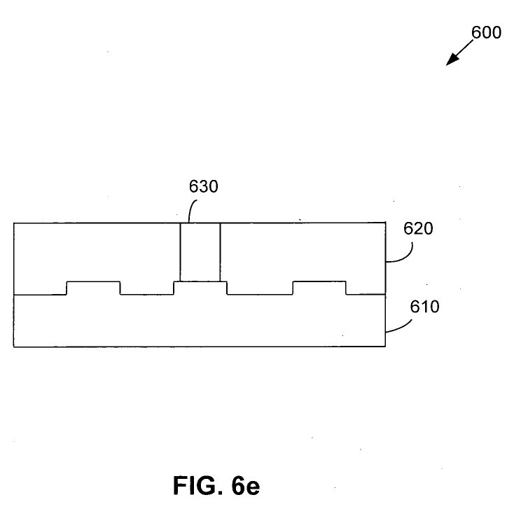

FIG. 6a illustrates a microelectronic structure according to an embodiment of the present invention. An interlayer dielectric (ILD) 620, may be disposed on a conductive layer 610 that may comprise various circuit elements such as transistors, metal interconnect lines, etc. The ILD 620 may comprise a porous diamond layer, similar to the diamond layer 102 of FIG. 1c, and/or it may comprise a layered diamond structure, similar to the layered diamond structure 470 of FIG. 4e. The ILD 620 may comprise a dielectric constant of about 1.95 or less, and may comprise a mechanical strength greater than about 6 GPa.

A hydrogen plasma 650 may be applied to the ILD 620. The hydrogen plasma 650 may act to terminate, or passivate, dangling bonds that may be present on the surface of the ILD 620. It will be appreciated that hydrogen passivated diamond surfaces, such the passivated top surface 622 (FIG. 6b), exhibit very low coefficients of friction, which may then facilitate subsequent polishing process steps, such as a chemical mechanical polishing (CMP) process, as is known in the art and will be described further herein.

A trench 625 may be formed in the ILD 620 (FIG. 6c). A conductive layer 630 may be formed within the trench 625 and on the passivated top surface 622 of the ILD 620 (FIG. 6d). The conductive layer 630 may preferably comprise copper. A polishing process, such as a CMP process, may be applied to the conductive layer 630. Because the ILD 620 comprises a passivated top surface 622, the selectivity (i.e., difference in polishing rate) between the conductive layer 630 and the ILD 620 is extremely high, and may comprise greater than 100:1 in one embodiment. Another advantage of the passivated top surface 622 of the ILD 620 is that because the passivated top surface comprises a low coefficient of friction, CMP pads used during the CMP process may be used for a much longer period of time before pad replacement is required.

As detailed above, the present invention describes the formation of diamond films that exhibit low dielectric constants (less than about 2) and superior mechanical strength. Thus, the diamond film of the present invention enables fabrication of microelectronic structures which are robust enough to survive processing and packaging induced stresses, such as during chemical mechanical polishing (CMP) and assembly processes.

Although the foregoing description has specified certain steps and materials that may be used in the method of the present invention, those skilled in the art will appreciate that many modifications and substitutions may be made. Accordingly, it is intended that all such modifications, alterations, substitutions and additions be considered to fall within the spirit and scope of the invention as defined by the appended claims. In addition, it is appreciated that various microelectronic structures, such as interlayer dielectric oxides, are well known in the art. Therefore, the Figures provided herein illustrate only portions of an exemplary microelectronic device that pertains to the practice of the present invention. Thus the present invention is not limited to the structures described herein.

What is claimed is:

1. A structure comprising:
a diamond layer comprising a substantial amount of pores.

2. The structure of claim 1 wherein the diamond layer comprises a dielectric constant below about 1.95.

3. The structure of claim 1 wherein the diamond layer comprises a strength above about 6 GPa.

4. The structure of claim 1 wherein the diamond layer comprises an ILD layer.

5. A structure comprising:
a diamond layer comprising a mixture of sp2 bonds and sp3 bonds; and
a substantially sp2 free diamond layer disposed on the diamond layer, wherein the substantially sp2 free diamond layer comprises sp3 bonds.

6. The structure of claim 5 wherein the substantially sp2 free diamond layer does not comprise an appreciable amount of sp2 bonds.

7. The structure of claim 5 wherein the structure comprises a dielectric constant less than about 1.95, and a strength above about 6 GPa.

8. The structure of claim 5 wherein the structure comprises an ILD layer.

9. A structure comprising:
a conductive layer disposed on a substrate; and
a diamond layer disposed on the conductive layer, wherein the diamond layer comprises pores.

10. The structure of claim 9, wherein the diamond layer comprises an ILD.

11. The structure of claim 9, wherein the diamond layer comprises a dielectric constant lower than about 1.95.

12. The structure of claim 9, wherein the diamond layer comprises a strength above about 6 GPa.

13. The structure of claim 9, wherein the diamond layer comprises a polishing rate about 100 times greater than that of the conductive layer.
